(19) United States
(12) Patent Application Publication
(10) Pub. No.: US 2018/0197535 A1
(43) Pub. Date: Jul. 12, 2018

(54) Systems and Methods for Human Speech Training

(71) Applicant: BOARD OF REGENTS, THE UNIVERSITY OF TEXAS SYSTEM, Austin, TX (US)

(72) Inventors: Md. Motasim BELLAH, Norman, OK (US); Jodi M. TOMMERDAHI, Dallas, TX (US); Mohammad Raziul HASAN, Arlington, TX (US); Samir M. IQBAL, Mansfield, TX (US)

(73) Assignee: Board of Regents, The University of Texas System, Austin, TX (US)

(21) Appl. No.: 15/743,272

(22) PCT Filed: Jul. 11, 2016
(86) PCT No.: PCT/US2016/041765

§ 371 Date: Jan. 9, 2018

Related U.S. Application Data
(60) Provisional application No. 62/190,606, filed on Jul. 9, 2015.

(51) Int. Cl. G10L 15/187; G10L 15/22; G10L 21/14; G10L 25/60; G10L 25/72; G10L 15/30; G09B 19/04; G09B 21/00; G09B 5/06

(52) U.S. Cl. CPC G10L 15/187; G10L 15/22; G10L 21/14; G10L 25/60; G09B 5/06; G10L 15/30; G09B 19/04; G09B 21/009; G10L 25/72

(57) ABSTRACT

Language learning and speech training techniques are implemented to provide automated and real-time quantitative feedback to the user. Sound samples produced by a speaker are transcribed and analyzed against database sound samples to: provide speech therapy, compute the accuracy of a speaker's pronunciation, aid in learning a foreign language, and help members of the deaf community learn to communicate with spoken language.

### CROSS-REFERENCE TO RELATED APPLICATIONS

This application claims the benefit of the filing date of U.S. Provisional Patent Application No. 62/190,606, which was filed on Jul. 9, 2015 by the inventors of this application, and which is incorporated herein by reference in its entirety.

### STATEMENT REGARDING FEDERALLY SPONSORED RESEARCH

Part of the work performed during development of this invention utilized U.S. Government funds under a grant from the National Science Foundation (ECCS-1201878). The U.S. Government may have certain rights in this invention.

### TECHNICAL FIELD OF THE INVENTION

The present disclosure relates generally to techniques for audio signal processing. More particularly, the disclosure relates to systems and methods for language learning and pronunciation assistance.

### BACKGROUND

Spoken language is the principal means of communication between humans and is learned at the very early stages of individual human development. However, not all children learn a language at a same rate. Some take longer than others because learning to speak a language takes a large amount of information processing and coordinated muscular activities. As a result, many children face language learning difficulties. Some people face language learning difficulties or encounter such difficulties due to medical conditions or injuries (e.g., brain injuries) affecting the speech process.

Learning a foreign language is difficult and rewarding at the same time. There are relatively few tools on the market to help a speaker learn a new language. Having a trainer is helpful but it does not solve all the problems. Usually, someone from a different geographical location cannot distinguish many similar sounds from other languages, particularly vowel sounds, which are fundamental language building blocks. This ability is lost by the age of approximately 18 months in humans if not exposed to non-native sounds. The learning challenges are even greater when a speaker's native language is very different from the one he is trying to learn. To learn how to pronounce a sound accurately, the speaker needs to hear the sound. But ironically, he cannot hear the differences; that is why he cannot pronounce the sound properly in the first place. Even though the trainer pronounces distinct sounds (for example “live” and “leave”), the speaker does not hear any difference. It makes it very difficult for a foreign language learner to hear the difference between the target sound and his own production, leading to a foreign accent when speaking the new language. The challenges for people with hearing impairments who wish to use oral language are even greater. Without quantitative feedback, the vicious loop of learning impediment cannot be broken.

In conventional speech therapy, a speech and language therapist listens to each word produced by the individual, manually transcribes the words, evaluates performance of each word production, and then decides what therapy the person might need. Therapists teach the person to produce the sounds with which they are having difficulty, often by explaining positions of the lips and tongue. The person's ability to practice sounds and get appropriate feedback is therefore limited to the time that the person is in the presence of the therapist. The process is very tedious, laborious, and prone to human error.

Accordingly, a need remains for improved techniques to learn languages, overcome speech impediments, and improve pronunciation.

### SUMMARY

According to a first aspect of the invention, a method is provided for human speech training. The method comprising: receiving a sound sample from a human speaker; comparing the received sound sample against sound samples in a database by performing a mathematical analysis to determine a match between the received sound sample and a sound sample in the database; and providing real-time quantitative feedback to the speaker regarding the match determined between the received sound sample and the database sound sample.

In another aspect of the invention, a system for speech training is provided. The system comprising a processor programmed to: receive a sound sample from a human speaker; compare the received sound sample against sound samples in a database by performing a mathematical analysis to determine a match between the received sound sample and a sound sample in the database; and provide real-time quantitative feedback to the human speaker regarding the match determined between the received sound sample and the database sound sample.

Other aspects of the embodiments described herein will become apparent from the following description and the accompanying drawings, illustrating the principles of the embodiments by way of example only.

### BRIEF DESCRIPTION OF THE DRAWINGS

The following figures form part of the present specification and are included to further demonstrate certain aspects of the present claimed subject matter, and should not be used to limit or define the present claimed subject matter. The present claimed subject matter may be better understood by reference to one or more of these drawings in combination with the description of embodiments presented herein. Consequently, a more complete understanding of the present embodiments and further features and advantages thereof may be acquired by referring to the following description taken in conjunction with the accompanying drawings, in which like reference numerals may identify like elements, wherein:

FIG. 1(a) depicts a time domain representation of a sound, according to some embodiments;

FIG. 1(b) depicts a magnitude spectrum of the representation in FIG. 1(a);

FIGS. 2(a)-2(d) depict screenshots of an application, according to some embodiments;

FIGS. 3(a)-3(d) depict screenshots of an application, according to some embodiments;

FIGS. 4(a)-4(b) depict screenshots of an application, according to some embodiments;

FIG. 5(a) depicts a screenshot of an application, according to some embodiments;

FIG. 5(b) depicts a time domain representation of a sound, according to some embodiments;

FIG. 6(a) depicts a time domain representation of sound according to some embodiments;

FIG. 6(b) depicts a filtered version of the representation in FIG. 6(a);

FIG. 6(c) depicts a representation of an automatically detected signal block, according to some embodiments;

FIG. 7(a) depicts a FFT magnitude spectrum of a sound, according to some embodiments;

FIG. 7(b) depicts a FFT magnitude spectrum of the filtered version of the spectrum in FIG. 7(a);

FIG. 8(a) illustrates a parameterization plot of a sound in one trial, according to some embodiments;

FIG. 8(b) illustrates a parameterization plot of a sound in another trial, according to some embodiments;

FIG. 9(a) depicts a spectrogram of a sound, according to some embodiments;

FIG. 9(b) depicts a representation of a detected signal block, according to some embodiments;

FIG. 10 is a flow chart illustrating, at a top level, a method for human speech training, according to some embodiments; and

FIG. 11 depicts a schematic of a computer system, according to some embodiments.

### NOTATION AND NOMENCLATURE

Certain terms are used throughout the following description and claims to refer to particular system components and configurations. As one skilled in the art will appreciate, the same component may be referred to by different names. This document does not intend to distinguish between components that differ in name but not function. In the following discussion and in the claims, the terms “including” and “comprising” are used in an open-ended fashion, and thus should be interpreted to mean “including, but not limited to . . . .” As used herein, the term “sound sample” is understood to encompass a word, a phrase, a vowel sound, a consonant sound, a single syllable sound, or a multisyllabic sound.

The term FFT stands for Fast Fourier Transform. It does not refer to a new or different type of Fourier transform but rather refers to a very efficient algorithm for computing the Discrete Fourier Transform (DFT). The time taken to compute a DFT on a computer depends essentially on the number of multiplications involved. N² multiplications are required to compute DFT of a data series with N elements. But FFT requires only N log₂(N). The mathematical insight which leads to this algorithm is the realization that a DFT of a sequence of N points can be written in terms of two DFTs of length N/2. If the length of the sequence (N) is a power of two, it is possible to apply this mathematical decomposition recursively until there is only a single point to compute DFT. Even if N is not a power of 2, it can be made so by appending appropriate number of zeros at the end. DFT of a sequence x(n) with length N,

$$X [ k ] = {\sum }_{n = 0}^{N - 1} x [ n ] {e}^{- \frac{2 π j n k}{N}} = {\sum }_{n = 0}^{N - 1} x [ n ] {W}_{N}^{n k}$$

where

$${W}_{N}^{n k} = {e}^{- \frac{2 π j n k}{N}} .$$

It is easy to realize that the same values of W_{N}^{nk} are calculated many times during the DFT computation.

Using the symmetry property, the above expression can be split into two similar terms.

$$X [ k ] = {\sum }_{n = 0}^{N - 1} x [ n ] {e}^{- \frac{2 π j n k}{N}} = {\sum }_{n = 0 , n is even}^{N - 1} x [ n ] {W}_{N}^{n k} + {\sum }_{n = 0 , n is odd}^{N - 1} x [ n ] {W}_{N}^{n k} = {\sum }_{r = 0}^{\frac{N}{2} - 1} x [ 2 r ] {W}_{N}^{2 rk} + {\sum }_{r = 0}^{N - 1} x [ 2 r + 1 ] {W}_{N}^{( 2 r + 1 ) k} = {\sum }_{r = 0}^{\frac{N}{2} - 1} {x}_{1} [ r ] {W}_{\frac{N}{2}}^{r k} + {W}_{N}^{k} {\sum }_{r = 0}^{N - 1} {x}_{2} [ r ] {W}_{\frac{N}{2}}^{r k}$$

where x₁ [r]=x[2r] and x₂ [r]=x[2r+1]. So X[k]=X₁(k)+W_{N}^{k}X₂(k).

From the analysis, it is evident that an N point DFT can be evaluated by computing two N/2 points DFT and adding them. This process can be continued until there is one data point left. Due to the exponential nature of the algorithm, it enhances the speed of the computation.

Linear correlation coefficient is a measure of the strength and the direction of a linear relationship between two variables. The following formula can be used to compute it.

$$r = \frac{n \sum x y - ( \sum x ) ( \sum y )}{\sqrt{n ( \sum {x}^{2} ) - {( \sum x )}^{2}} \sqrt{n ( \sum {y}^{2} ) - {( \sum y )}^{2}}}$$

where x and y are two data sets of length n and r is the correlation coefficient between them. It can be used to compute matching between two data sets.

### DETAILED DESCRIPTION OF DISCLOSED EMBODIMENTS

The foregoing description of the figures is provided for the convenience of the reader. It should be understood, however, that the embodiments are not limited to the precise arrangements and configurations shown in the figures. Also, the figures are not necessarily drawn to scale, and certain features may be shown exaggerated in scale or in generalized or schematic form, in the interest of clarity and conciseness. The same or similar parts may be marked with the same or similar reference numerals.

While various embodiments are described herein, it should be appreciated that the present invention encompasses many inventive concepts that may be embodied in a wide variety of contexts. The following detailed description of exemplary embodiments, read in conjunction with the accompanying drawings, is merely illustrative and is not to be taken as limiting the scope of the invention, as it would be impossible or impractical to include all of the possible embodiments and contexts of the invention in this disclosure. Upon reading this disclosure, many alternative embodiments of the present invention will be apparent to persons of ordinary skill in the art. The scope of the invention is defined by the appended claims.

Illustrative embodiments of the invention are described below. In the interest of clarity, not all features of an actual implementation for all embodiments are necessarily described in this specification. In the development of any such actual embodiment, numerous implementation-specific decisions may need to be made to achieve the design-specific goals, which may vary from one implementation to another. It will be appreciated that such a development effort, while possibly complex and time-consuming, would nevertheless be a routine undertaking for persons of ordinary skill in the art having the benefit of this disclosure.

Human ears may not perceive the subtle differences in the human voice, but an audio signal processing system can computationally analyze multiple features ranging from spectral magnitudes, formant frequencies, time domain features, pitch, phase spectrum, etc. As a result, differences that are not discernible to human ears can be determined in an audio signal processing system.

Daily human communication is almost entirely dominated by speech. It is the primary source of raw information used by a listener to recover and comprehend a message. A sound wave is the end product of a complex speech production mechanism. It is a disturbance that results from vibration and propagates through any elastic medium. All vibration sources create a back and forth motion in the propagation medium. The number of complete cycle of back and forth per unit time is called the frequency of the sound. A commonly used unit of frequency is Hertz (Hz). If an object makes 100 complete cycle of vibration in 2 seconds, its frequency is 50 Hz.

Sound can be produced from anything that vibrates in the audible range (roughly 20 Hz to 20 KHz for humans). A series of coordinated muscle actions is required to produce a sound. The whole process of speech production is controlled by the human brain. In the beginning of sound production, the vocal cords are closed. The air pressure from the lung keeps building due to this closure. When the muscles of the vocal cords cannot hold the pressure any longer, air is suddenly released in the form of little pops, buzzes, and hisses. Then, these sounds are filtered in the laryngeal tube and modified with the help of the lips, tongue, soft palate, jaw and other articulators to produce meaningful sounds.

The rate at which the vocal cords chop the air flow is called the fundamental frequency. When the sound passes through the laryngeal tube, it resonates depending on the shape of the tube. Each resonance will produce a spectral peak in the sound spectrum. These spectral peaks are known as formant frequencies. There are a few fundamental and formant frequencies associated with each vowel. For any vowel, the first three formant frequencies are the most important characteristics. The range of frequencies used to pronounce a vowel may vary depending on the speaker. As a result, distributions of frequencies in the sound spectrum can be used as a metric to analyze speech. It may also be possible to find a trend in a person's voice by monitoring their spectrum over a period of time. The larynx acts as a closed tube on one end; it produces only the odd harmonics, i.e., the formant frequencies are odd multiple (1, 3, 5, etc.) of the fundamental frequencies. Since vocal cords act like a variable length tuning fork made up with material of variable elasticity, they can produce a wide range of frequencies by changing the muscle tension.

The ears receive this complex sound and break it into its frequency components in a similar fashion as the prism splits white light into color components. In principle, an individual speaker can make a finite set of sounds in almost an infinite number of ways in the time domain. It may thus not be possible for the human brain to store all these time domain permutations of sounds.

Throughout this disclosure the capital letters “A”, “E”, “I”, “O”, “U” represent certain symbols from the International Phonetic Alphabet (IPA), where one symbol refers to one sound and one sound only. The IPA symbols are most often written between forward slashes and are used in dictionaries to indicate the pronunciation of words. Specifically, as used herein, “A” stands for the IPA vowel symbol /e_{I}/, “E” stands for IPA vowel symbol /i:/, “Γ” stands for the IPA vowel symbol /a_{I}/, “O” stands for the IPA vowel symbol / [symbol] /and “U” stands for the IPA vowel symbol /ju:/. Thus, these single capital letter abbreviations respectively represent the pronunciation of the vowels in the words bad, bed, bid, bod and bud. It is contemplated that other embodiments featuring other vowel sounds, of any language, may be used instead of or in addition to those described in the present disclosure.

Different sounds have their own characteristic frequencies. Once a sound sample is collected, the sample can be converted into frequency domain by computing the FFT. The average of FFT magnitude spectra may then be calculated. The magnitude spectrum shows distinct characteristics of the sound for each speaker. Each spectrum from a single speaker is significantly distinct from others. Thus the magnitude spectra may be used as the speaker's signature. The variations are clearly noticeable when plotted. The magnitude spectra can be stored to generate a database of known and identified sound samples.

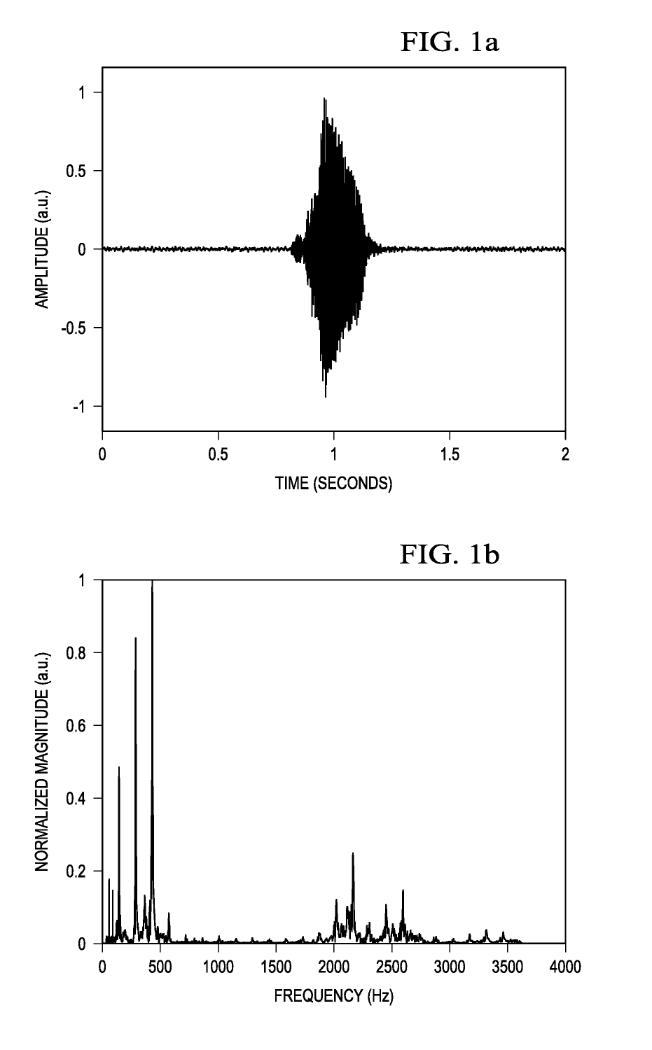

A time domain and its corresponding frequency domain representation of a sample sound are depicted in FIG. 1. The time domain representation of the sound “A” (recording time=2 seconds, sampling frequency=22050 Hz) is shown in FIG. 1a. The y-axis magnitude unit of the recording in FIG. 1a, and in other sound sample signal representations disclosed herein, is depicted in arbitrary units (a.u.). The distinctive frequency components are clearly visible from the normalized magnitude spectrum, as shown in FIG. 1b. Most of the information is confined within 0 to 5 KHz. As illustrated in FIG. 1b, the magnitude spectrum of a particular sound is divided into regions that contained most of its features. The magnitude spectrum contains information about the type of sound, speaker, pace, tone, pitch, etc. If a database of stored signatures is created, a percentage matching of a test sample and the stored signatures can be performed by computing the standard correlation coefficient. During sound production, humans generate specific bands of frequencies for a particular sound. The distribution of these bands and frequencies are distinct for different individuals. The whole spectrum may be analyzed to find such regions, called “significant bands.” For each significant band, the correlation coefficient can be computed and used to identify the speaker. The correlation coefficient determined for a particular sample and its own stored signature will differ compared to the coefficients derived for other test sample-signature matchings. The coefficient difference margins can be quantified and plotted for analysis of a “correlation distance” to further distinguish and identify the subject test sample. The features of human sound may vary in time (i.e., morning, noon, night). Analysis of the differences in these features based on production times will also aid to further distinguish and identify a subject speaker.

With the increasing popularity of smart mobile phones or devices, or mobile devices with built in operating systems (such as iOS), computer program developers have generated a multitude of applications (or “Apps”) available to the mobile device user. For example, users of Apple® platforms such as the iPhone have access to a multitude of applications pertaining to everything from games, to reference applications (i.e., a dictionary application or language translation application) to productivity applications from the Apple® App Store. Similarly, users of Android® platforms have access to applications from the Android® Market or the Amazon® Appstore for Android®, and users of Microsoft® platforms such as the Windows® devices have access through the Windows® Phone Store. Additional devices such as the Apple® iPad or Kindle Fire® may include modifications to the graphic user interface (GUI) to take advantage of the large multi-touch screen and advanced computing capabilities of such devices compared to a mobile phone.

Thus, in addition to implementation via standard computer processors, embodiments of the invention may be implemented utilizing smart devices such as an iPad or Android®, entailing their tablet capabilities (as well as capabilities of other similar devices like a smartphone, a tablet computer, a portable media player, a netbook, a smartbook, an e-Reader, etc.). An embodiment of the invention entails an Android® OS application that uses standard Google® database and speech recognition technology to “listen” to a speaker and keep a record of all sounds spoken. The application provides an automated system that monitors the progress of pronunciation skills of people with speech disorders. It stores words in a database. In one implementation, words produced by the individual are analyzed to compute the accuracy of the pronunciation in real-time. The technique provides the ability to investigate the source location of the speech disorder. The sound or word delivery by the speaker is recorded and quantified to measure progress with minimal human interaction.

In an embodiment of the invention, a speech training application was written on an open access platform (MIT App Inventor) developed by MIT for Android® OS. The application can be run on any Android® device. Those skilled in the art will appreciate that other development software may be used to generate similar applications for any device running any operating system. In one implementation, the application performs voice to text conversion of the sound sample (e.g., a word) received from the individual. Individual sound samples, such as words, can be manually corrected prior to storage in a database. Practice sound samples can be saved in the local memory of the device. The sound samples are indexed while being saved in the database, facilitating later sorting and easy indexed retrieval of sound samples. The application has the functionality to compute the resemblance of a transcribed sound sample received from the speaker with all of the sound samples stored in the database. By analyzing mismatches between the target database sound sample and the sound sample produced by the speaker, important information for language therapy can be determined.

Every sound in human speech is produced by the various combinations of components that make up the human sound producing apparatus (vocal cords, tongue, teeth, lips, oral and nasal cavities). If it is found that a person has difficulty pronouncing a particular type of sound, the person can work on a device configured with a disclosed speech training system to improve his sound production. A speech therapist will thus have a definitive means of diagnosing speech impediments and gauging progress and improvement in speech development.

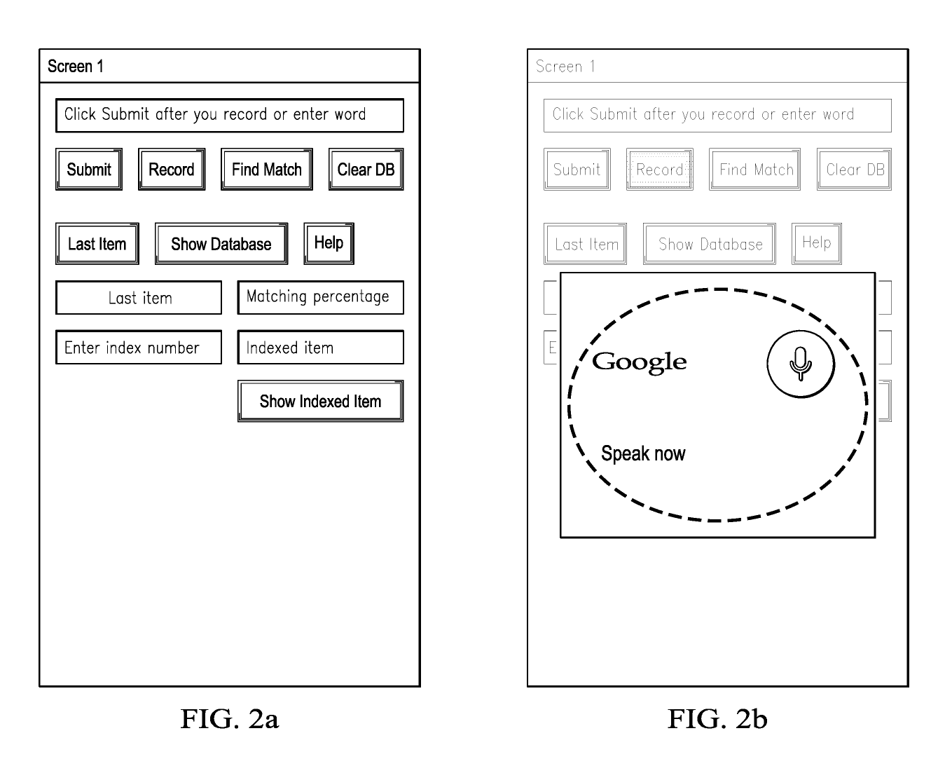

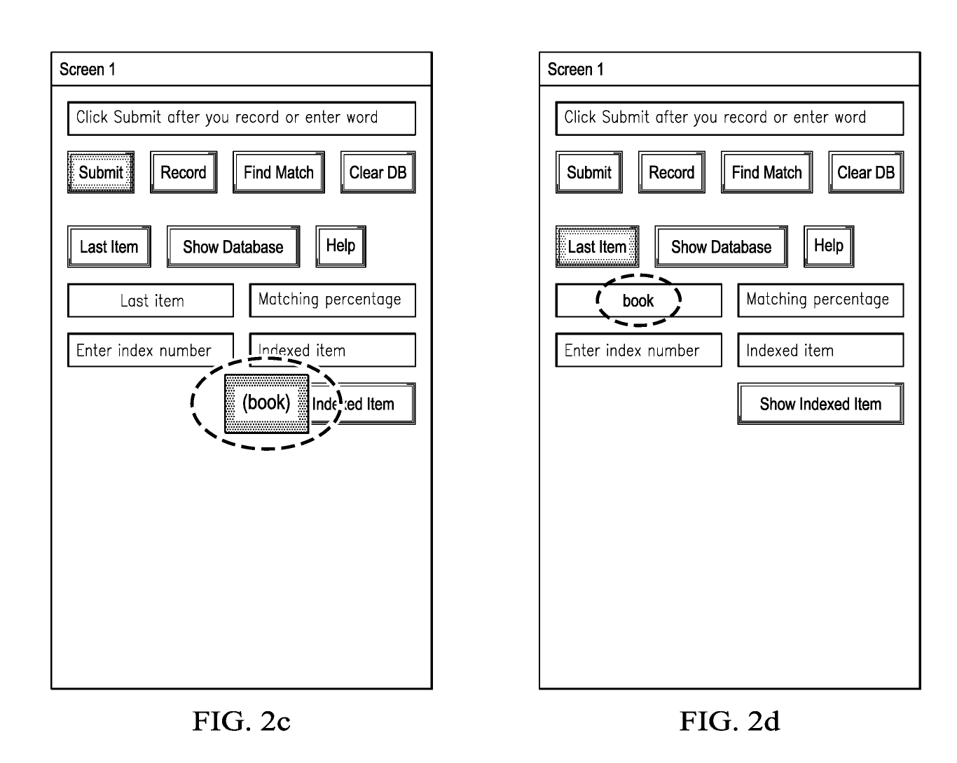

FIGS. 2a and 2b illustrates a collection of various screenshots of the Android OS application of one embodiment of the invention. FIG. 2a depicts a screenshot of the home screen. The process begins with the person speaking the sound sample as he would in normal conversation. Upon tapping the “Record” button, the received sound sample is record. FIG. 2b depicts the screenshot when “Record” is pressed; a small window prompts the speaker to produce a sound sample (circle). Once speaking is finished, the algorithm detects the sound sample and shows it in a textbox. FIG. 2c depicts a screenshots of the screen while saving a sound sample. Once the sound sample is received from the speaker, the speaker presses “Submit” to save the sound sample in the database. In FIG. 2c, the screen shows an example of the spoken sound sample (the word “book”) while saving it to the database. While saving the sound sample in the database, the received sound sample will momentarily appear at the center of the screen to prompt the speaker that it is properly saved. When a speaker forgets the last sound sample that was saved in the database, pressing the “Last Item” button retrieves the sound sample from the database. FIG. 2d shows the last sound sample that was stored, in the textbox below the “Last Item” screen button. If correction of a produced sound sample is desired, the speaker can modify the sound sample by typing the correction or modification.

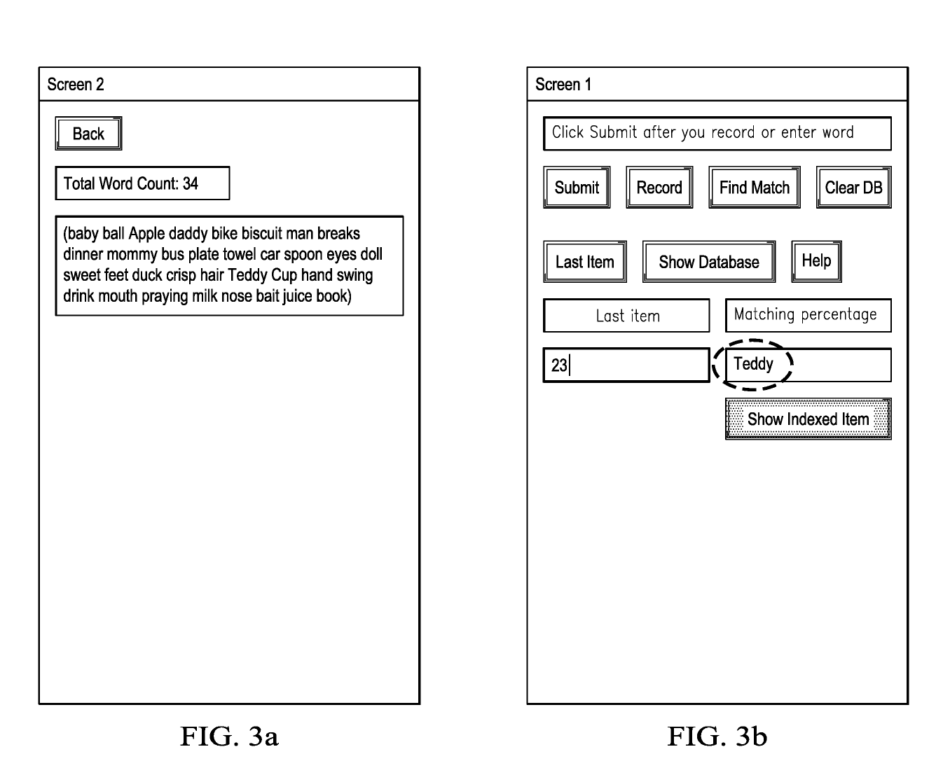

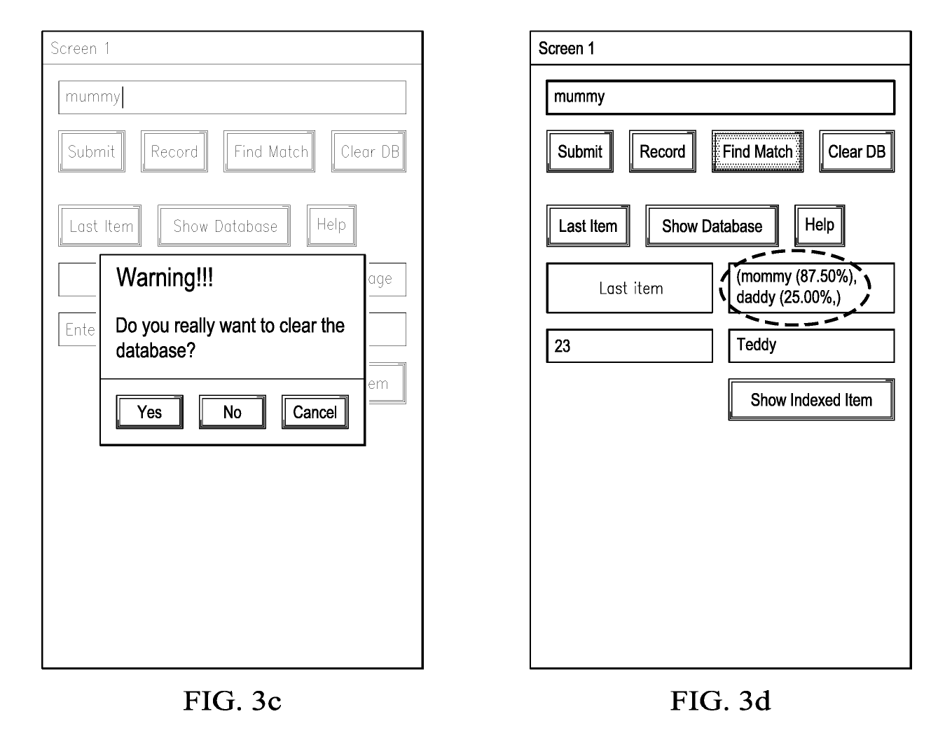

By pressing the “Show Database” button, a speaker can access all the sound samples stored. When “Show Database” is activated, the screen depicted in FIG. 3a is shown. FIG. 3b depicts a screenshot of how to retrieve an indexed item from the database. When an index number is entered in the text box labeled “Enter Index Number” and “Show Indexed Item” is pressed, the algorithm pulls up the sound sample associated with that index number from the database and shows it in a text box right beside the index number. In order to clear the database, the “Clear DB” button is used. Since this feature can erase everything from the database with a click, a warning message is displayed to prompt the user to confirm the deletion process. This feature provides an extra safety layer to prevent inadvertent loss of all data. FIG. 3c illustrates this process. A sound sample, e.g., a word, can be searched throughout the database by entering it in the top text box and pressing the “Find Match” button as shown in FIG. 3d.

An embodiment of the algorithm compares the received sound sample against sound samples in an established database by performing a mathematical analysis to determine a match between the received sound sample and a sound sample in the database. The algorithm calculates the percent match with each sound sample in the database. Once the percentages are computed, it sorts them in a descending order and picks the first two sound samples in the database that produce a higher match. For example, a child was asked to pronounce “mommy” and he produced the word “mummy”, which matches 87.5% with a word “mommy” and 25% with the word “daddy” stored in the database. These two words showed the highest matching with the received and recorded word. As shown in FIG. 3d, these two words are immediately displayed by the application, providing real-time quantitative feedback to the speaker regarding the match determined between the received sound sample and the database sound sample. The application not only tells a speaker that the sound production was not accurate, but also provides a quantitative feedback about how accurate it was. Speech and language therapists can now quantitatively evaluate the speech production of each patient. Since each sound is produced from a specific location of the sound-producing apparatus, the system offers a non-invasive way to investigate the source of a speech disorder. Word delivery by a speaker can be recorded and quantified to measure progress automatically.

In some embodiments the analysis entails assigning mathematical weights to individual components (e.g., vowels, consonants, single syllable sounds, multisyllabic sounds) of the sound samples. In one algorithm embodiment, normal percentage matching is used to assign equal weight to each letter of a word. Humans hear consonant sounds with more certainty than vowels. Thus, another algorithm embodiment assigns more weight to consonants (1.5) and less weight to vowels (1) to find the matching. Humans do not listen to all the parts of a word with equal importance. In general, people pay more attention to terminal sounds than to the intermediate ones. Thus, another algorithm embodiment assigns highest weight (2) to the first and last letter and then considers non-uniform weighting (consonants 1.5 and vowels 1) for all the other letters in the middle. vowel sound, a consonant sound, a single syllable sound, and a multisyllabic sound

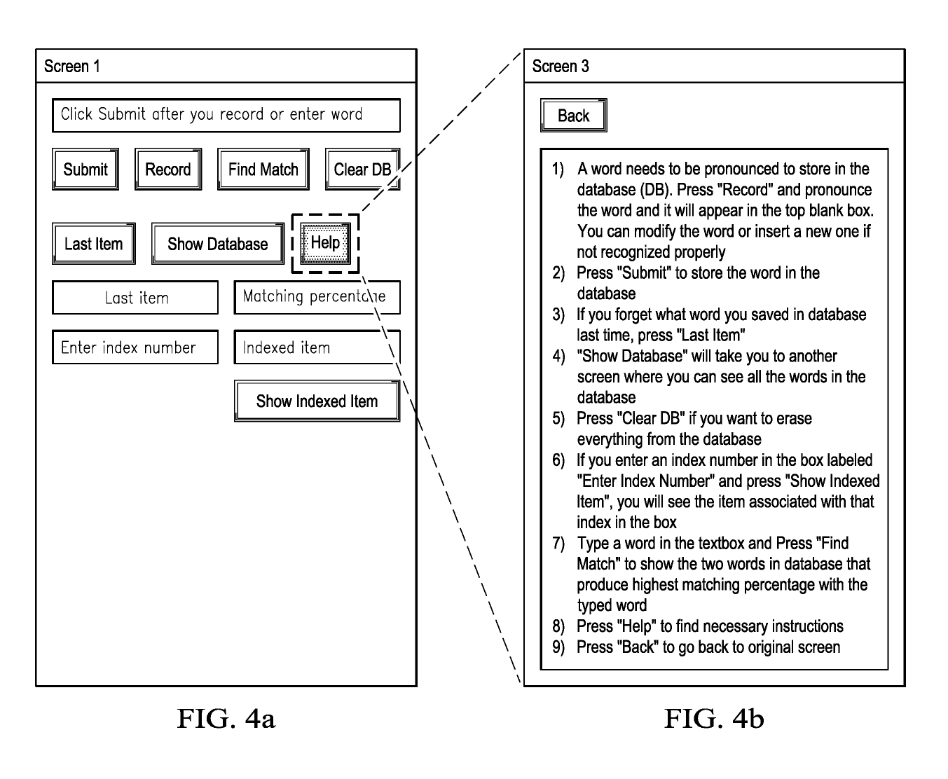

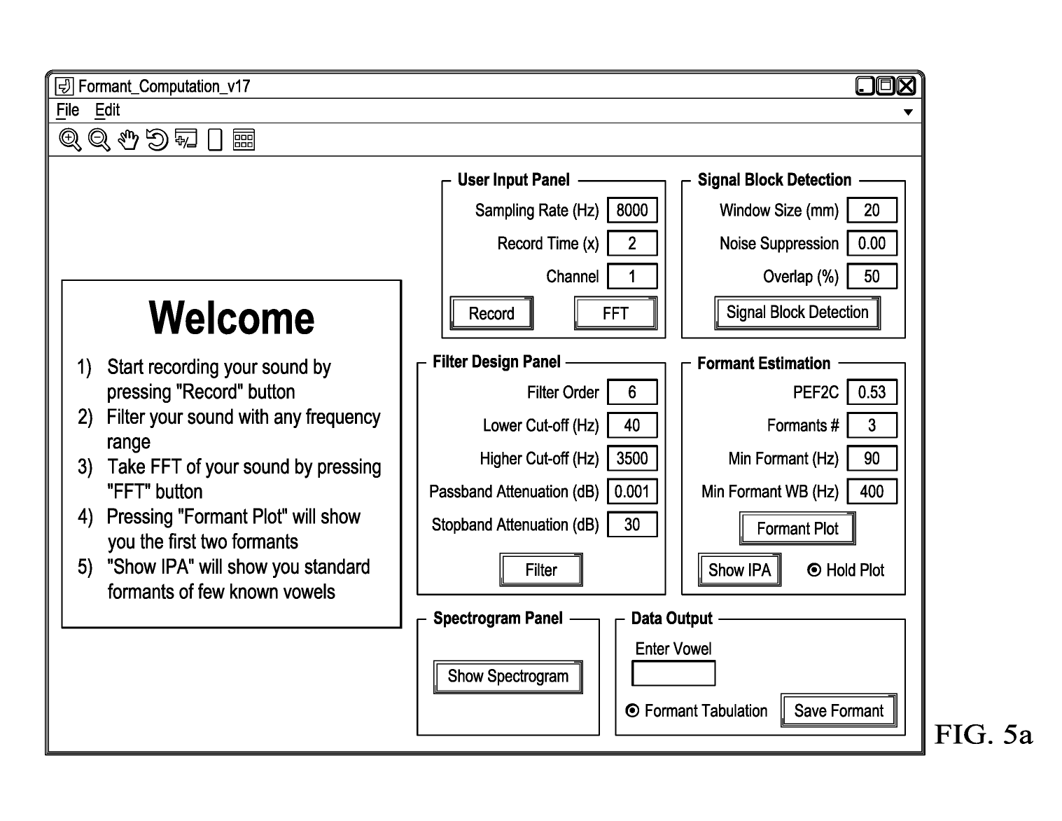

FIG. 4 depicts other screenshots of the system. FIG. 4a is a screenshot with the highlighted “Help” button. The “Help” button is to guide the speaker to the functionalities of each button in detail. All the necessary instructions for running the application are tabulated. As shown in FIG. 4b, when the “Help” button is pressed, a new screen that describes the functionality of each button in the application appears. Each new screen displays a “Back” button, which allows the speaker to backtrack to the home screen.

According to Benade (A. H. Benade, “Fundamentals of musical acoustics,” Oxford University Press, London., 1976), formants can be defined as the peaks of the spectrum envelope of a sound. The Acoustical Society of America defines formant as a range of frequencies in which there is an absolute or relative maximum in the sound spectrum. Formants are essentially the resonance frequencies of a sound. In the process of sound production, a puff of air is pushed upward through the laryngeal tube. The vocal cords chop the air with a certain frequency and the vibrations produced act as the fundamental frequency of that sound. The sound is later shaped by mouth cavity, tongue, teeth, and lips. The fundamental frequency produces multiple resonances in the mouth cavity depending on the position of tongue, teeth, and lips. Formants are one of many aspects of sound that can be used to gauge the accuracy of sound production. Other mathematical features such as spectrograms, coefficient of wavelet transformations, coefficients of short time Fourier transform, singular value decomposition, etc., can be used to quantify the quality of the sound production. One or more of these features may be implemented along with formants to perform the disclosed sound analysis techniques.

Other embodiments of the invention pertaining to human speech training provide an accent trainer, particularly suited for foreign language learners and people with hearing impairments. These embodiments help a speaker produce sounds more accurately, without any accents. Embodiments provide real-time quantitative feedback regarding the sound produced by comparing produced sound samples with a pool of sound samples from native speakers. These applications are more like a target practice game, where the speaker can see the sound target and practice until the target is reached.

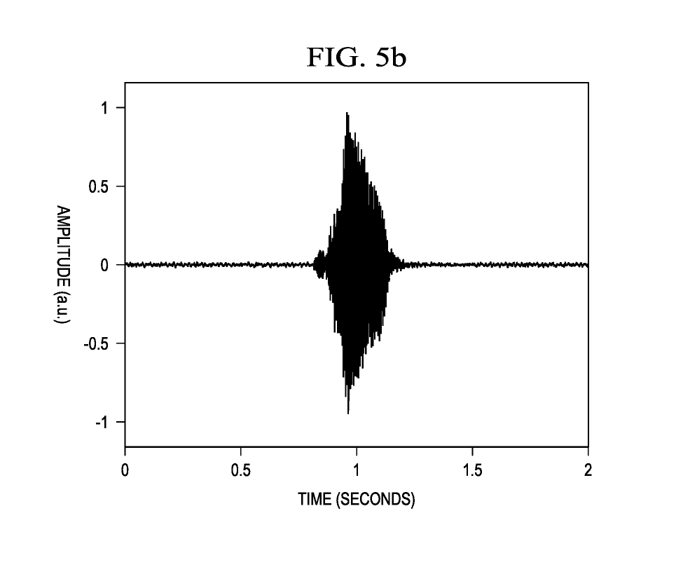

One embodiment of this speech training system is an application package developed on a MATLAB® GUI. The application prompts a speaker to pronounce a sound sample in a given language, records the received sound sample, and then provides real-time quantitative feedback on a GUI to show how close the attempt was compared to a ‘native speaker’ sound sample. As a result, a non-native speaker can accurately evaluate his performance of the sound production, even if he cannot hear the subtle differences in the sound. The speaker can attempt to copy each sound sample multiple times, trying to bring his sound production closer to the target. FIG. 5a depicts a home screen of the MATLAB® GUI application embodiment of the invention.

As shown in FIG. 5a, the speaker is initially provided with a set of instructions on the panel. Hovering a mouse pointer to any button brings up a box with more information about that button. All the values displayed in the text boxes are default values. Any of the values can be tweaked to get desired results. Pressing the “Record” button starts recording of a sound sample from a speaker. The application will prompt the speaker to wait until they hear a sound and to make sure the microphone is turned on. After the received sound sample is recording, the time domain signal of the received sound sample is displayed. For example, FIG. 5b illustrates the time domain signal of the sound of English vowel “A.”

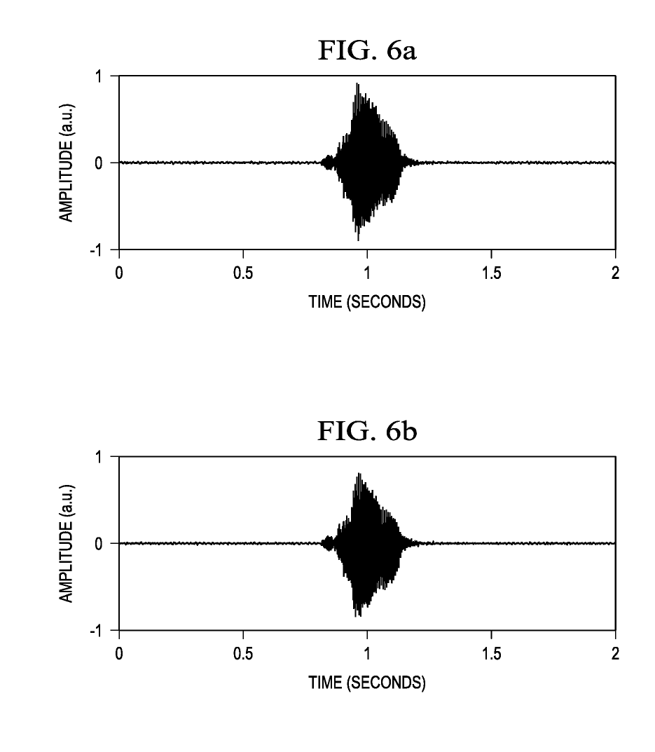

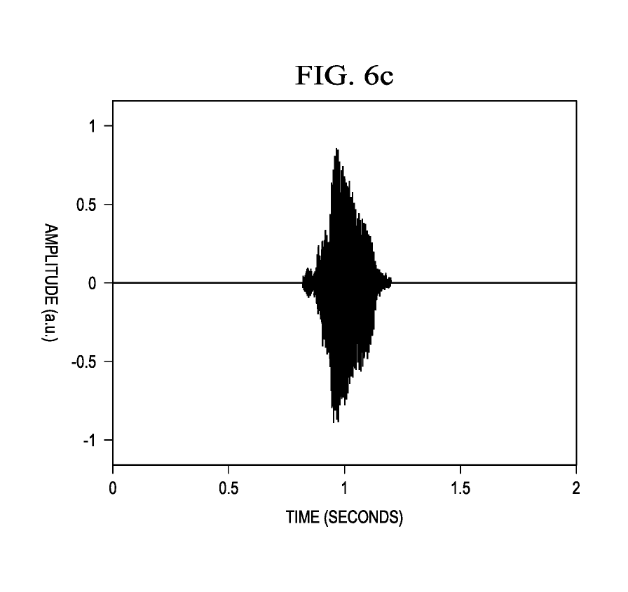

FIGS. 6a, 6b, and 6c respectively depict a time domain signal of the sound “A”, its filtered version (f_{CL}=40 Hz and f_{CH}=3500 Hz), and detected signal block of the filtered version. The “Signal Block Detection” button on the application is used to detect exactly when the signal block appears in the time series as shown in FIG. 6c.

Pressing the “Filter” button of the application removes noise from the signal. In one embodiment, a six order elliptic band-pass filter was used. The filter takes out any unwanted signal that falls outside of an established band (e.g., 40-3500 Hz). Cut-off frequencies may be chosen taking into account the fact that most frequency components of the vowels lie well within a set range. Attenuation for pass and stop bands were 0.001 and 30 dB, respectively.

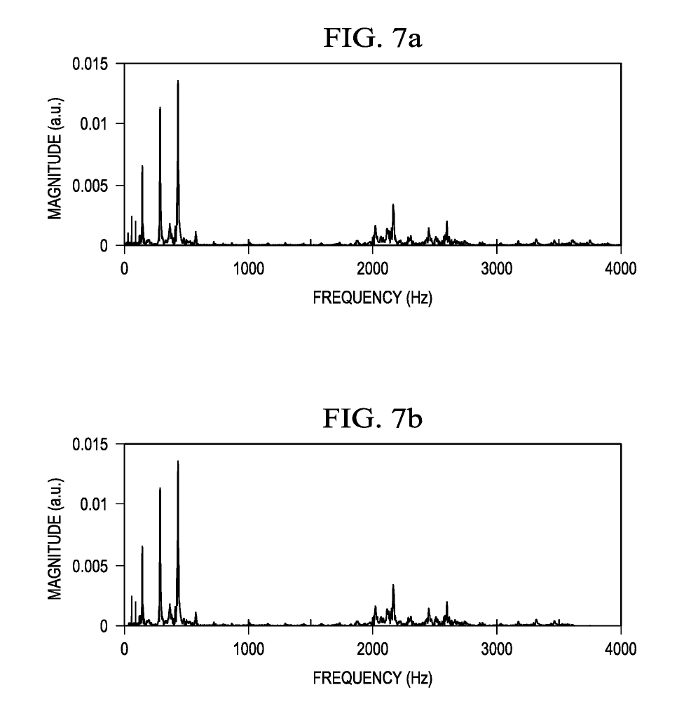

FIG. 7a is illustrates a FFT magnitude spectrum of sound of “A”. FIG. 7b illustrates a FFT magnitude spectrum of the filtered version of the same signal. Pressing the “FFT” button performs fast Fourier transform on the signal.

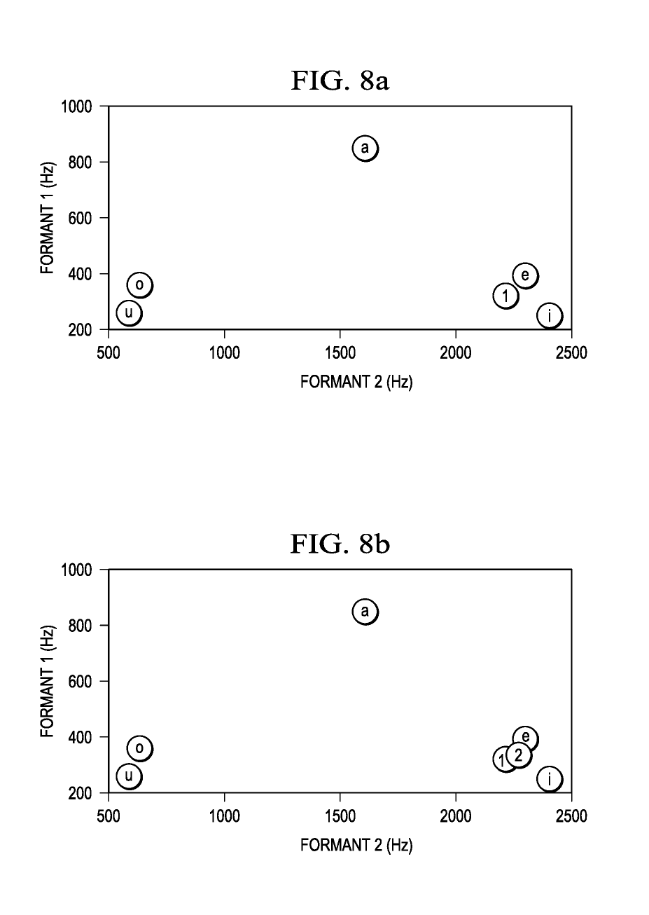

FIG. 8a illustrates a parameterization of vowel sound “E” in a first trial. FIG. 8b illustrates the parameterization in a second trial of vowel sound “E”. The vowel name is input in the text box on the “Data Output” panel as shown in FIG. 5a. Once a name is entered in the text box mentioned above, pressing “Formant Plot” will provide a prompt to save the formant frequencies in an Excel file. This name is used to index the data.

Once pressed, the “Formant Plot” button, a circle with an Arabic numeral inside representing the formant frequencies (first two formants) will appear on a 2D plot as shown in FIG. 8a. There's an Arabic numeral inside the circle which is the sequence number of the recording (1 in the illustrated case, indicating the first trial). There are five other data points on the plot (circles with a letter inside), which are the standard locations of the five vowels [a] as in bat, [e] as in bed, [i] as in tee, [u] as in coo, [o] as in code. The input vowel sound sample is the circled one with an Arabic numeral inside it, representing the formant frequency parameter.

The first three formant frequencies will be displayed in a text box (right) on the “Data Output” panel which is located on the bottom right corner of the screen (not shown). A speaker can try multiple times to bring his sound production closer to the targets as shown in FIG. 8b. For example, the circle with the number “2” in FIG. 8b represents the formant frequencies of the sound sample produced by the speaker in a second trial recording. As shown in FIG. 8b, the second sound sample iteration produced by the speaker is closer to the representation of the vowel sound “E” than is the circle with the number “1”.

If a speaker unselects the button “Hold Plot”, the previous data point will be cleared from the plot, showing only the current data point. Keeping this button on will allow the speaker to hold the consecutive formant points on the plot to compare among them as shown in FIG. 8b.

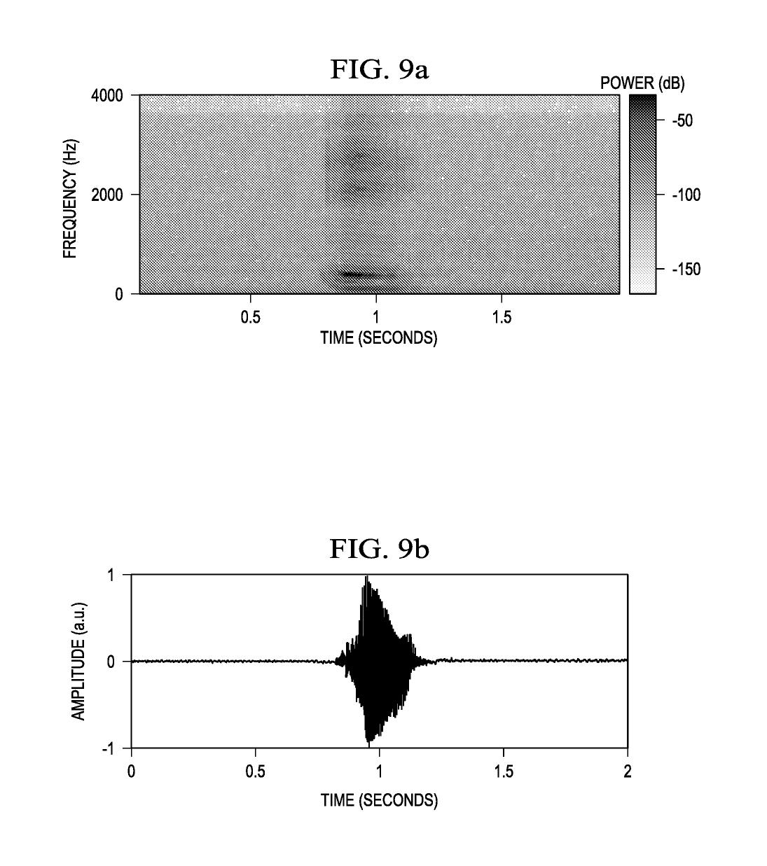

The “Show Spectrogram” button allows a speaker to observe the spectrogram of the sound as shown in FIG. 9a. Due to the computation loading, this process usually takes a little longer. Specifically, FIG. 9a depicts the spectrogram of the sound of “A”. FIG. 9b depicts the detected signal block.

Keeping the “Formant Tabulation” radio button on allows the speaker to store formant frequencies in a matrix which can be saved later by clicking “Save Formant” button (located on the “Data Output” panel). It prompts the speaker to select a file name and location and save the data in .xlsx format, for example. Any displayed image can be saved by clicking “File” and “Save as”. The application allows the speaker to choose a suitable output format (e.g., png, jpeg, and emf). Additional functionalities include the “Show IPA” and “Edit” button.

The speech training embodiments disclosed herein may be implemented to provide the quantitative feedback in any one of various forms or formats, including visually (e.g., as text or images on a display), audibly (e.g., computer generated audio output), or in a haptic format (e.g., a physical format such as a computer generated braille pad, vibrations, or lights). The information may also be conveyed to the speaker by any conventional means known in the art including, for example, signals transmitted through Bluetooth or RFID devices.

By providing real-time quantitative feedback of the speaker's sound production, embodiments of the invention act as the natural auditory feedback loop that adults may have used as infants to learn their native language. Moreover, the applications allow a speaker to work on a particular part of his sound producing apparatus since each sound sample is produced by the participation from different parts in the mouth and laryngeal tube. The applications also provide speech learning tools for those in the deaf community who wish to use oral language, providing them with visual, auditory, or haptic feedback. Advantages provided by the disclosed invention embodiments include, but are not limited to: automation; tracking individual sound sample and overall performance of each user; cloud based accessibility; a personalized voice therapist; remote supervision; real-time feedback; and complementarity with existing applications.

In some embodiments, word stress may be accounted for in the analysis. For example, if a speaker mistakenly put the stress on the first syllable of “computer” instead of the second, this would be fed back to the speaker that the stress is incorrect. The system would provide feedback suggesting that the stress be placed on the second syllable in the word “computer”. As such, the system may recognize and chart each individual sound that makes up a word, and also recognize syllable stress within single words. Other embodiments may provide a quantitative assessment of a speaker after he reads an entire paragraph. The assessment may include, but is not limited to, the number of times the speaker puts stresses in the wrong places, the number of syllables mispronounced, inappropriate intonations, etc. It is also envisaged that embodiments may be implemented with some or all of the described elements configured into game forms, making practice more engaging.

According to some embodiments, a database is generated and populated for comparison using English sound samples. However, it will be appreciated by those skilled in the art that embodiments of the disclosed inventions may be implemented with appropriately populated databases and software interfaces for use by speakers of any language. Embodiments may also be implemented with databases containing selected combinations of sound samples (e.g., one consonant and all vowels or all consonants and one vowel, etc.). Other embodiments may be implemented with a database comprising only those sound samples considered and selected as standards for the desired application.

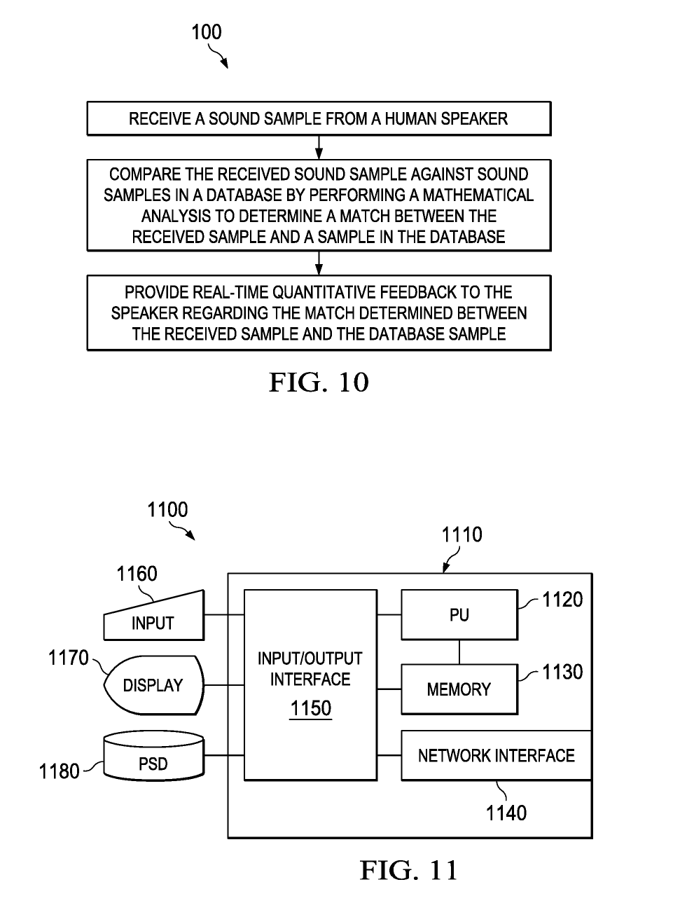

FIG. 10 is a flow chart illustrating a method 100 of the invention, i.e., a method of speech training. At a first step, a sound sample is received from a human speaker. At a second step, the received sound sample is compared against sound samples in a database by performing a mathematical analysis to determine a match between the received sound sample and a sound sample in the database. At a third step, real-time quantitative feedback is provided to the speaker regarding the match determined between the received sound sample and the database sound sample.

In addition to the devices previously mentioned, the following is a description of an exemplary computer system useful for carrying out functionality and implementation of one or more embodiments disclosed herein.

Such a computer system may include at least one processor, which may be a programmable control device that may be programmed to perform steps or processes described herein. Such a processor may be referred to as a central processing unit (CPU) and may be implemented as one or more CPU and/or GPU (Graphics Processing Unit) chips. The processor may be in communication with network connectivity (or network interface) devices, with input/output (I/O) devices, and with a non-transitory machine-readable medium, which may be a non-transitory computer-readable medium.

The network connectivity or network interface devices may include modems, modem banks, Ethernet cards, universal serial bus (USB) cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, or other network devices. These network connectivity/interface devices may enable the processor to communicate with the Internet or one or more intranets or other communication networks. With such a network connection, the processor may transmit information to and receive information from other entities, via the network, in the course of performing steps or processes disclosed herein.

The I/O devices may include printers, monitors, displays, speakers, speech synthesizers, touch screens, keyboards, keypads, switches, dials, mice, microphones, voice recognition devices, card readers, tape readers, or other input or output devices.

The machine-readable medium may comprise memory devices including secondary storage, read only memory (ROM), and random access memory (RAM). The secondary storage may include any form of optical or magnetic storage including solid-state storage, such as magnetic disks (fixed, floppy, and removable) and tape; optical media such as CD-ROMs and digital video disks (DVDs); and semiconductor memory devices such as Electrically Programmable Read-Only Memory (EPROM), Electrically Erasable Programmable Read-Only Memory (EEPROM), Programmable Gate Arrays and flash devices. The secondary storage may be used for non-volatile storage of data and may be used as an over-flow data storage device if the RAM is not large enough to hold all working data. The secondary storage may be used to store instructions or programs that are loaded into the RAM when such instructions or programs are selected for execution. Execution of such instructions and programs cause the processor to perform any of the steps or processes described in this disclosure. The ROM may also be used to store instructions or programs and may be used to store data to be read by the processor during program execution. The ROM is a non-volatile memory device which typically has a small memory capacity relative to the larger memory capacity of the secondary storage. The RAM is used to store volatile data and may also be used to store programs or instructions. Access to both the ROM and the RAM is typically faster than to the secondary storage.

The processor executes codes, computer programs, and scripts that it accesses from secondary storage, the ROM, the RAM, or the network connectivity/interface devices. The terms “logic” and “module” as referred to herein relate to structure for performing one or more logical operations. (Modules may be provided for performing operations and functions described herein, e.g., voice/speech recognition modules, voice/speech decomposition/analysis/comparison modules, etc.) For example, a module may comprise circuitry which provides one or more output signals based upon one or more input signals. Such circuitry may comprise a finite state machine that receives a digital input and provides a digital output, or circuitry which provides one or more analog output signals in response to one or more analog input signals. Such circuitry may be provided in an application specific integrated circuit (ASIC) or field programmable gate array (FPGA). Also, a module may comprise machine-readable instructions stored in a memory in combination with processing circuitry to execute such machine-readable instructions. However, these are merely examples of structures which may provide logic, and embodiments disclosed herein are not limited in this respect. Also, items such as applications, modules, components, etc. may be implemented as software constructs stored in a machine-readable storage medium, and those constructs may take the form of applications, programs, subroutines, instructions, objects, methods, classes, or any other suitable form of control logic. Steps or processes described herein may thus be performed by software, hardware, firmware, or any combination of one or more of these.

The computer system may include a server and one or more user interface devices, which may be client devices. As suggested by the server-client configuration, the system may be used to interface with a number of users.

The communication network(s) may include any one or more of a wired network, a wireless network (e.g., Wi-Fi network or cellular network), and facilities for data transmittal over telecommunications networks and services, and the network interface may include appropriate corresponding interfaces. Communication over the communication network(s) may occur in real-time when network connectivity is available. Alternatively, or when network connectivity is not available for immediate transmission, the data for transmission over the network may be stored locally in memory/storage and transmitted at a later time. Memory/storage may also include one or more databases, which may be used to store, e.g., databases of voice/speech data as described herein, generated output data, etc.

Description of an exemplary computer system useful for implementing a user interface, according some embodiments, is now provided. According to some embodiments, the user interface device may be implemented using the same computer that is used for the voice/speech recognition/analysis applications described herein (e.g., authentication, voice to text conversion, medical analysis of speech organs and diagnosis of conditions thereof, feedback for language learning, etc.). However, the user interface may also be implemented by one or more separate computer devices.

A user interface device may include the following components: a processor, a memory, secondary storage, an input device, an output/display device, and a network interface (for each of these components, the user interface device may include one or more of the given component, e.g., one or more input devices, one or more output/display devices, etc.). A general description of these elements of the user interface device has been provided by the immediately preceding description of the same or analogous/similar elements of the exemplary computer system. Software applications may be loaded into the memory. Such software applications may include a software application for implementing a user interface. In such a user interface, screenshots may be displayed on the output/display device, and the user may interact with the user interface device via the input device(s). Input devices that may be provided on the user interface device to facilitate such interactions may include a microphone, speaker, keyboard, stylus, touchscreen, etc. The network interface is configured for enabling the user to communicate with (e.g., transmit information to and receive information from) other elements of the system and entities external to the system, via a communication network.

The user interface device may be a mobile (e.g., client) device or a web (e.g., client) device. Mobile devices are electronic devices that are portable or mobile and include, e.g., mobile phones, such as smartphones (e.g., iPhones™, Android™ phones, Windows™ phones, BlackBerry™ smartphones), tablets (e.g., iPads™, Android™, Microsoft Surface™ tablets), etc. Web devices are electronic devices that are not considered (as) portable or mobile as mobile devices and include, e.g., personal computers, such as laptop and desktop computers, etc. The user interface device may (but need not) be remote from other elements of the system.

FIG. 11 illustrates a non-limiting example of a computer system such as described above, although the figure does not necessarily comprehensively depict all the components of such system. As seen in FIG. 11, example device 1100 comprises a programmable control device 1110 which may be connected to input device(s) 1160 (e.g., microphone, keyboard, mouse, touch screen, etc.), output devices such as a speaker (not shown) and a display 1170 and program storage device 1180. Also, included with programmable control device 1110 is a network interface 1140 for communication via a network with other computers and infrastructure devices (not shown).

Program control device 1110 may be programmed to perform methods in accordance with this disclosure. Program control device 1110 comprises a processor unit (PU) 1120, memory 1130, and input-output (I/O) interface 1150 (in communication with input device 1160 and output devices (1170 and other) described above. Processing unit 1120 may include any programmable controller device including, for example, the Intel Core®, Pentium® and Celeron® processor families from Intel and the Cortex and ARM processor families from ARM (INTEL CORE, PENTIUM and CELERON are registered trademarks of the Intel Corporation. CORTEX is a registered trademark of the ARM Limited Corporation. ARM is a registered trademark of the ARM Limited Company). Memory 1130 may include one or more memory modules and comprise random access memory (RAM), read only memory (ROM), programmable read only memory (PROM), programmable read-write memory, and solid state memory. One of ordinary skill in the art will also recognize that PU 1120 may also include some internal memory including, for example, cache memory. PU 1120 may be configured to provide a voice processor to implement the disclosed techniques. In some embodiments, aspects of the voice processing may be shared between the PU 1120 and an input device 1160 configured with a processor to perform such processing. Further details that may be applicable to example device 1100 have been described above preceding the description of FIG. 11.

After reading the description presented herein, it will become apparent to a person skilled in the relevant art how to implement embodiments disclosed herein using computer systems/architectures and communication networks other than those described herein.

Embodiments disclosed herein demonstrate improvements in the functioning of a computer and in other technologies/technical fields, e.g., audio signal processing and voice/speech recognition/processing/analysis/transcription, etc. For example, embodiments perform functions/applications described herein faster, in a more automated fashion, more accurately, and with a higher success rate, compared to prior art; again, disclosed embodiments permit a computer to operate faster and using less memory compared to prior art. It is understood that embodiments disclosed herein provide practical applications, such as voice-to-text transcription, providing graphical and quantitative feedback to language learners, etc. It will also be understood that, with regard to functions/applications performed by embodiments disclosed herein, there exist many ways of performing such functions/applications other than those disclosed herein.

As mentioned, embodiments disclosed herein pertain to voice/speech processing, analysis and the like for purposes such as voice-to-text transcription, providing feedback to language learners, etc. Such embodiments may also be understood as falling under the rubric of audio signal processing and speech training. Accordingly, it will be understood that such embodiments provide practical applications and improvements in the functioning of a computer and in other technologies/technical fields comparable to those provided by image (visual signal) processing (e.g., digital image processing, video signal processing).

In light of the principles and example embodiments described and illustrated herein, it will be recognized that the example embodiments can be modified in arrangement and detail without departing from such principles. Also, the foregoing discussion has focused on particular embodiments, but other configurations are also contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise.

Similarly, although example processes have been described with regard to particular operations performed in a particular sequence, numerous modifications could be applied to those processes to derive numerous alternative embodiments of the present invention. For example, alternative embodiments may include processes that use fewer than all of the disclosed operations, processes that use additional operations, and processes in which the individual operations disclosed herein are combined, subdivided, rearranged, or otherwise altered.

Accordingly, it will be understood that systems and methods claimed or described herein need not include all of the functional, structural, or operational elements claimed or described herein, but may include any one or more of them. For example, where a claimed system or method includes multiple operations or other elements, it is also possible to provide a claimed system or method including any one or more of those multiple operations or other elements, unless the disclosure hereinabove indicates otherwise.

This disclosure may include descriptions of various benefits and advantages that may be provided by various embodiments. One, some, all, or different benefits or advantages may be provided by different embodiments.

In view of the wide variety of useful permutations that may be readily derived from the example embodiments described herein, this detailed description is intended to be illustrative only, and should not be taken as limiting the scope of the invention. What is claimed as the invention, therefore, are all implementations that come within the scope of the following claims.

1. A method for human speech training, comprising:
receiving a sound sample from a human speaker;
comparing the received sound sample against sound samples in a database by performing a mathematical analysis to determine a percent match between the received sound sample and one of the sound samples in the database;
using the percent match as quantitative feedback to the human speaker in real time; and
notifying the human speaker that higher percent match indicates higher pronunciation accuracy.

2. The method of claim 1, wherein:
the comparing step comprises performing a mathematical weighting between the received sound sample and the database sound samples to determine a percent match between the received sound sample and the one of the sound samples in the database; and
the using the percent match step comprises revealing the one of the sound samples in the database determined to be the match with the received sound sample, wherein the one of the sound samples in the database determined to be the match with the received sound sample is revealed in a visual, audible, or haptic format.

3. The method of claim 2, wherein the performing the mathematical analysis comprises assigning a mathematical weight to a component of the received sound sample, the component selected from the group consisting of a vowel sound, a consonant sound, a single syllable sound, and a multisyllabic sound.

4. The method of claim 2, wherein the performing the mathematical analysis comprises:
transcribing the received sound sample to corresponding text;
assigning a mathematical weight to at least one component of the transcribed written text; and
comparing the assigned weighting of the transcribed written text against weightings assigned to the sound samples in the database to determine the percent match between the received sound sample and the one of the sound samples in the database.

5. The method of claim 1, wherein:
the comparing step comprises producing a frequency parameter of the received sound sample and frequency parameters of the database sound samples; and
the using the percent match step comprises displaying a representation of the frequency parameter of the received sound sample along with a representation of a frequency parameter of at least one database sound sample.

6. The method of claim 5, further comprising:
receiving repeated sound samples from the human speaker;
producing a frequency parameter of each received sound sample; and
sequentially displaying a representation of the frequency parameter of each of the received sound samples, wherein the display indicates the representation of the received sound samples closest to a selected representation of a frequency parameter of a database sound sample.

7. The method of claim 1, wherein the received sound sample and the database sound samples are selected from the group consisting of a vowel sound, a consonant sound, a single syllable sound, and a multisyllabic sound.

8. The method of claim 1, wherein the performing the mathematical analysis comprises assigning a set mathematical weight to consonants and a different set mathematical weight to vowels in the received sound sample.

9. The method of claim 1, wherein the performing the mathematical analysis comprises assigning a greater mathematical weight to first and last letters in a word of the received sound sample compared to a mathematical weight assignment given to letters in a middle of the word.

10. The method of claim 1, wherein the using the percent match step comprises providing quantitative or graphical feedback pertaining to a degree of accuracy of the human speaker's utterance of the received sound sample relative to the one of the sound samples in the database determined to be the match with the received sound sample.

11. A system for speech training, comprising a processor programmed to:
receive a sound sample from a human speaker;
compare the received sound sample against sound samples in a database by performing a mathematical analysis to determine a percent match between the received sound sample and one of the sound samples in the database;
use the percent match as quantitative feedback to the human speaker in real time; and
notify the human speaker that higher percent match indicates higher pronunciation accuracy.

12. The system of claim 11, wherein:
the mathematical analysis comprises performance of a mathematical weighting between the received sound sample and the database sound samples to determine a percent match between the received sound sample and the one of the sound samples in the database; and
the quantitative feedback comprises a revelation of the one of the sound samples in the database determined to be the match with the received sound sample, wherein the one of the sound samples in the database determined to be the match with the received sound sample is revealed in a visual, audible, or haptic format.

13. The system of claim 12, wherein the mathematical analysis comprises assignment of a mathematical weight to a component of the received sound sample, the component selected from the group consisting of a vowel sound, a consonant sound, a single syllable sound, and a multisyllabic sound.

14. The system of claim 12, wherein the processor is further programmed to:
transcribe the received sound sample to corresponding text;
assign a mathematical weight to at least one component of the transcribed written text; and
compare the assigned weighting of the transcribed written text against weightings assigned to the sound samples in the database to determine the percent match between the received sound sample and the one of the sound samples in the database.

15. The system of claim 11, wherein:
the mathematical analysis comprises production of a frequency parameter of the received sound sample and frequency parameters of the database sound samples; and
the quantitative feedback comprises a display of a representation of the frequency parameter of the received sound sample along with a representation of a frequency parameter of at least one database sound sample.

16. The system of claim 15, wherein the processor is further programmed to:
receive repeated sound samples from the human speaker;
produce a frequency parameter of each received sound sample; and
sequentially display a representation of the frequency parameter of each of the received sound samples, wherein the display indicates the representation of the received sound samples closest to a selected representation of a frequency parameter of a database sound sample.

17. The system of claim 11, wherein the received sound sample and the database sound samples are selected from the group consisting of a vowel sound, a consonant sound, a single syllable sound, and a multisyllabic sound.

18. The system of claim 11, wherein the mathematical analysis comprises assignment of a set mathematical weight to consonants and a different set mathematical weight to vowels in the received sound sample.

19. The system of claim 11, wherein the mathematical analysis comprises assignment of a greater mathematical weight to first and last letters in a word of the received sound sample compared to a mathematical weight assignment given to letters in a middle of the word.

20. The system of claim 11, wherein the quantitative feedback comprises provision of quantitative or graphical feedback pertaining to a degree of accuracy of the human speaker's utterance of the received sound sample relative to the one of the sound samples in the database determined to be the match with the received sound sample.
